(19) United States
(12) Patent Application Publication
(10) Pub. No.: US 2019/0236249 A1
(43) Pub. Date: Aug. 1, 2019

(54) SYSTEMS AND METHODS FOR AUTHENTICATING DEVICE USERS THROUGH BEHAVIORAL ANALYSIS

(71) Applicant: Citrix Systems, Inc., Fort Lauderdale, FL (US)

(72) Inventors: Chris Pavlou, Boca Raton, FL (US); Georgios Oikonomou, Patras (GR); Harold Teramoto, Margate, FL (US)

(21) Appl. No.: 15/884,993

(22) Filed: Jan. 31, 2018

(51) Int. Cl. G06F 21/31; G06F 15/18; G06F 21/55; G06F 17/30

(52) U.S. Cl. CPC G06F 21/316; G06F 15/18; G06F 17/11; G06F 17/3053; G06F 21/552

(57) ABSTRACT

Systems and methods for authenticating a user through behavioral analysis. The methods comprise: collecting observation data specifying an observed behavior of the user while interacting with a computing device; obtaining a confidence value reflecting a degree of confidence that the user is an authorized or unauthorized user of the computing device (where the confidence value is determined based on the observation data and a machine learning model trained with a known behavior pattern of the authorized user); using at least the confidence value and the observed behavior's amount of deviation from a normal behavior pattern to derive a risk level score value for a user account to which the computing device is associated; comparing the risk level score value to a threshold value; and performing at least one action to protect user account security when the threshold value is equal to or greater than the threshold value.

### BACKGROUND

### Statement of the Technical Field

The present disclosure relates generally to computing systems. More particularly, the present disclosure relates to implementing systems and methods for authenticating device users through behavioral analysis.

### Description of the Related Art

Security has always been a big issue in computing, including mobile computing. Passwords can often be compromised and unattended devices are an easy target.

### SUMMARY

The present disclosure concerns implementing systems and methods for authenticating a user through behavioral analysis. The methods comprise: collecting, by a computing device, observation data specifying an observed behavior of the user while interacting with the computing device; obtaining, by the computing device, a confidence value reflecting a degree of confidence that the user is an authorized user of the computing device or an unauthorized user of the computing device (where the confidence value is determined based on the observation data and a machine learning model trained with a known behavior pattern of the authorized user); using at least the confidence value and the observed behavior's amount of deviation from a normal behavior pattern to derive a risk level score value for a user account to which the computing device is associated; comparing, by the computing device, the risk level score value to a threshold value; and performing, by the computing device, at least one action to protect user account security when the threshold value is equal to or greater than the threshold value.

In some scenarios, the observation data specifies (1) the computing device's device type, (2) the computing device's orientation, and (3) a manner in which the user interacted with the computing device while using a software application (e.g., a Web Browser, an email application, or an editor application). The risk level score value is defined by the following Mathematical Equation

S_{useraccount}=f(Sₚᵣₑᵥᵢₒᵤₛ, W_{model}, Dₙₒᵣₘₐₗ, Aₛₜₐₜᵤₛ, Fₐₜₜₑₘₚₜₛ, C, X)

where S_{useracount} represents the risk level score value for the user account, W_{model} represents a weight value given to the computing device's device type, Dₙₒᵣₘₐₗ represents the observed behavior' s amount of deviation from the normal behavior pattern, Aₛₜₐₜᵤₛ represents a current authorization status, Fₐₜₜₑₘₚₜₛ represents a number of recently failed authorization attempts, Sₚᵣₑᵥᵢₒᵤₛ represents a previous risk level score value determined for the user account, C represents a number determined based on the confidence value, X represents a number dynamically selected from a set of pre-defined numbers based on a pre-defined criteria, f represents a function over all aforementioned parameters. The predefined criteria comprises at least one of a time since a low confidence level was obtained, a time since Dₙₒᵣₘₐₗ exceeded a threshold value, and a type of authentication method last used to authenticate the user's identity. The value of C is determined based on the difference between the confidence value and a reference confidence value. The function f describes a function that can define a linear or non-linear relation between the parameters. Function f can be statically defined or re-determined in response to trigger events. The trigger events can include, but are not limited to, a false conclusion that the user is the authorized or unauthorized user, expiration of a defined period of time, a location of the computing device, an operational characteristic of the computing device, an identity of the user, and/or an identity of an enterprise associated with the user account.

In those or other scenarios, the methods further involve collecting, by the computing device, training data specifying (1) the computing device's device type (e.g., mobile phone, tablet, desktop, etc.), (2) the computing device's screen size, (3) the computing device's operating system, (4) the computing device's orientation, (5) other computing device capabilities (e.g., presence of biometric sensors, touch screen force sensors, etc.), and (6) a manner in which the user interacted with the computing device while using a software application. The training data is used to train the machine learning module with the known behavior pattern of the authorized user. The training data may have been collected during a first time period when the user first logs into the user account, during a second time period when the software application is being used by the user for a first time, or during a third time period immediately after a successful authentication of the user.

### BRIEF DESCRIPTION OF THE DRAWINGS

The present solution will be described with reference to the following drawing figures, in which like numerals represent like items throughout the figures.

FIG. 1 is an illustration of an illustrative system.

FIG. 2 is an illustration of an illustrative architecture for the mobile device shown in

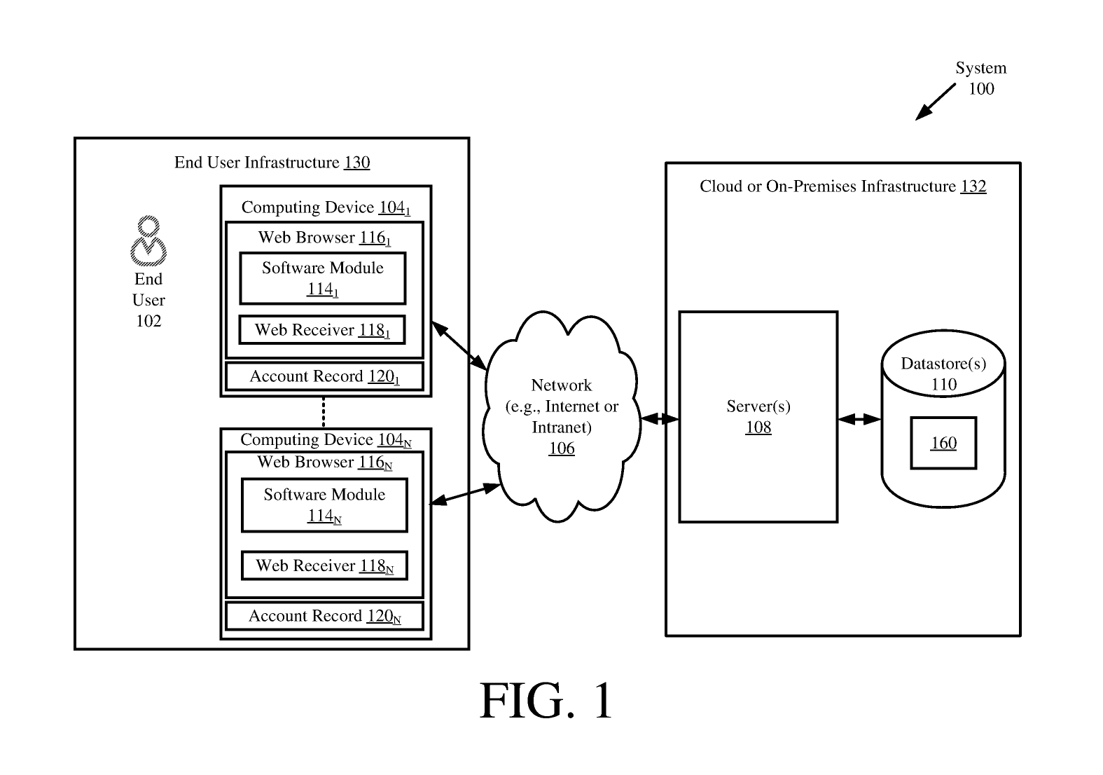

FIG. 1.

FIG. 3 is an illustration of an illustrative architecture for a server.

FIGS. 4A-4B (collectively referred to herein as “FIG. 4”) is a flow diagram of an illustrative method for authenticating mobile device users through different types of behavioral analysis.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

As noted above, security has always been a big issue in computing. Passwords can often be compromised and unattended devices are an easy target. Detecting unauthorized users in an efficient, effective and reliable way is one goal of the present solution. The purpose of the present solution is to use indirect, non-intrusive methods to collect user behavior data from a device that can have a supportive role in the decision making of whether the user is authorized to use the device or not, i.e., provide an extra degree of certainty besides passwords and other typical authentication methods that can be manipulated by a malicious user. The present solution can be extended to mobile devices (e.g., laptops), fixed devices (e.g., desktops), and any other device that humans interact with in some way. The present solution can also be extended to virtual applications running, for example, through a Web Receiver.

The present solution concerns systems and methods for authenticating mobile device users through different types of behavioral analysis. The present solution may be implemented as software embedded in a mobile application that runs transparently in the background. The embedded software is configured to continually and passively monitor and record user activity. The data resulting from such user activity is used to train machine learning models representing various user behavior patterns useful for subsequently predicting an unauthorized user's use of the device.

The present solution has many novel features including the following: user activity collected passively and in the background; adaptive data model training performed during key times of authorized use; and unauthorized use detections based on the results from combining predictions from multiple machine learning models with centralized user scores from all sources (e.g., a plurality of software applications executed on a single machine or multiple machines associated with a given user account). The key times of authorized use include, but are not limited to, a first time period immediately after the user first logs into the user account, a second time period when the software application is being used by the user for a first time, and/or a third time period immediately after a successful authentication of the user.

Referring now to FIG. 1, there is provided an illustration of an illustrative system 100. System 100 implements methods for authenticating device users through different types of behavioral analysis. In this regard, system 100 comprises end user infrastructure 130 and cloud or on-premises infrastructure 132. The end user infrastructure 130 can be associated with a customer, such as a business organization (e.g., a hospital or real estate firm). The customer has a plurality of end users 102. Each end user can include, but is not limited to, an employee. Each end user 102 uses one or more Computing Devices (“CDs”) 104₁ . . . , or 104_{N} for a variety of purposes, such as accessing and using software programs made available via cloud services provided by a cloud service provider. In this regard, each of the CDs 104₁-104_{N} includes, but is not limited to, a smart phone, a smart watch, a portable computer, a personal digital assistant, a tablet computer, a desktop computer, and/or laptop computer. The CDs 104₁-104_{N} are configured to facilitate access to applications and virtual desktops without interruptions resulting from connectivity loss. Accordingly, the CDs 104₁-104_{N} have installed thereon and execute various software applications. These software applications include, but are not limited to, Web Browsers 116₁-116_{N}, Web Receivers 118₁-118_{N}, electronic mail applications, and/or editor applications. Each of the listed types of applications are well known in the art, and therefore will not be described herein. Any known or to be known software application can be used herein without limitation.

In some scenarios, the Web Receivers 118₁-118_{N} can respectively include, but are not limited to, Citrix Receivers available from Citrix Systems, Inc. of Florida and Citrix Receivers for a web site available from Citrix Systems, Inc. of Florida. Citrix Receivers comprise client software that is required to access applications and full desktops hosted by servers remote from client devices (e.g., CDs). The present solution is not limited in this regard.

The CDs 104₁-104_{N} also have various information stored internally. This information includes, but is not limited to, account records 1201-120_{N}. The CDs 104₁-104_{N} are able to communicate with each other via an Intranet and with external devices via the Internet. The Intranet and Internet are shown in FIG. 1 as a network 106. The communications can be achieved using wired or wireless communication technology. The wired communication technology includes, but is not limited to, Digital Subscriber Line (“DSL”) based technology, and Multi-Protocol Label Switching (“MPLS”) based technology. The wireless communication technology includes, but is not limited to, mobile network technology (e.g., Long Term Evolution (“LTE”), third generation (“3G”), General Packet Radio Service (“GPRS”), etc.), WiFi, or Short Range Communication (“SRC”) technology (e.g., Bluetooth, Z-wave, etc.).

The external devices include one or more servers 108 located remotely from the CDs (e.g., at a cloud service provider facility). The server(s) 108 is(are) configured to facilitate access to applications and virtual desktops without interruptions resulting from connectivity loss. Accordingly, the server 108 has installed thereon and executes various software applications. The software applications include, but are not limited to, a StoreFront and a Desktop Delivery Controller (“DDC”). StoreFronts and DDCs are well known in the art, and therefore will not be described herein. Any known or to be known StoreFront and/or DDC can be employed herein.

The server 108 is also configured to access the datastore 110 in which various information 160 is stored, and is also able to write/read from the datastore(s) 110. The various information 160 includes, but is not limited to, software applications, code, media content (e.g., text, images, videos, etc.), user account information, user authentication information (e.g., a user name and/or facial feature information), machine learning algorithms, and/or machine learning models.

During the application's operation, an authentication process is performed for authenticating the end user 102 of a CD 104₁, . . ., or 104_{N}. The authentication process is performed to detect unauthorized users of the CD in an efficient, effective and reliable manner. The authentication process is provided with a higher degree of certainty as compared to conventional password based authentication methods and other conventional authentication methods which can be manipulated by malicious users.

The end user has a distinct way of interacting with the CD's input devices (e.g., a touch screen, a virtual keyboard, a physical keyboard, a microphone, a camera, etc.) when using a software application or program (e.g., Web Browser 1161, an email application, an editor application, etc.). During use, data is collected by a software module 114₁-114_{N} installed on top of the software application or program (e.g., Web Browser 1161). In some scenarios, the software module 114₁-114_{N} is executed inside the software application or program (e.g., Web Browser 116₁-116_{N} or Web Receiver 118₁-118_{N}). The collected data specifies at least (1) the MCD's device type (e.g., mobile phone, tablet, desktop, etc.), (2) the MCD's screen size, (3) the MCD's operating system, (4) the MCD's orientation, (5) other MCD capabilities (e.g., the presence of biometric sensors, touch screen force sensors, etc.), and (6) the manner in which the end user interacts with the MCD while using the software applications thereof. For example, the collected data indicates: (a) the speed, angle and force associated with a swipe gesture made using a particular software application or program (e.g., an email application or an editor application) running on a particular type of device (e.g., smart phone or tablet) while in a specific orientation (e.g., portrait or landscape); and/or (b) the speed, finger placement and force associated with keyboard typing of specific keys or pre-defined sequence of keys while using a particular software application or program (e.g., an email application or an editor application) running on a particular type of device (e.g., smart phone or tablet) while in a specific orientation (e.g., portrait or landscape). Distinct patterns of use for the end user 102 can be determined from the collected data. The collected information may be correlated with additional information. The additional information includes, but is not limited to, other CD information (e.g., the CD's location, network information, time of day, and/or date) or information coming from other external sources (e.g., an analytics platform, logs from other applications, etc.).

The collected data and/or correlated additional information is sent from the CD to the server 108 via network 106. The server 108 uses the received data/information to train a plurality of machine learning models with known user behavior patterns for the end user 102. Machine learning models are well known in the art, and therefore will not be described in detail herein. Any known or to be known machine learning model can be used herein. For example, binary classification based machine learning models and/or clustering based machine learning models is(are) employed here. The machine learning models are stored in the datastore 110 for later use.

The trained machine learning models are subsequently used by the server to determine a confidence value reflecting the degree of confidence that the end user 102 is an authorized user of the CD or an unauthorized user of the CD 104₁. The confidence value is determined based on the degree to which newly observed user behavior matches a corresponding one of the known user behavior patterns. In some scenarios, the confidence value is a percentage falling between 0% and 100%. The confidence value is then communicated from the server 108 to the CD 104₁.

In some scenarios, depending on CD's capabilities and connectivity (e.g., having sufficient CPU, memory, without Internet access, etc.), the machine learning models can be transferred to CD 104₁ and the process of determining the confidence value can take place in CD 104₁. In this case, when feasible, server 108 will be contacted and notified of the result of the inference and respond with some updated values or some updated actions.

In response to the received confidence value, the CD 104₁ performs operations to determine a score value for the user account to which the CD 104₁ is associated. The score value S_{useraccount} is generally defined by the following Mathematical Equation (1).

S_{useraccount}=f(Sₚᵣₑᵥᵢₒᵤₛ, W_{model}, Dₙₒᵣₘₐₗ, Aₛₜₐₜᵤₛ, Fₐₜₜₑₘₚₜₛ, C, X) (1)

where S_{useracount} represents the risk level score value for the user account, W_{model} represents a weight value given to the computing device's device type, Dₙₒᵣₘₐₗ represents the observed behavior' s amount of deviation from the normal behavior pattern, Aₛₜₐₜᵤₛ represents a current authorization status, Fₐₜₜₑₘₚₜₛ represents a number of recently failed authorization attempts, Sₚᵣₑᵥᵢₒᵤₛ represents a previous risk level score value determined for the user account, C represents a number determined based on the confidence value, X represents a number dynamically selected from a set of pre-defined numbers based on a pre-defined criteria, f represents a function over all aforementioned parameters. The predefined criteria comprises at least one of a time since a low confidence level was obtained, a time since Dₙₒᵣₘₐₗ exceeded a threshold value, and a type of authentication method last used to authenticate the user's identity. The value of C is determined based on the difference between the confidence value and a reference confidence value. The function f describes a function that can define a linear or non-linear relation between the parameters. Function f can be statically defined or re-determined in response to trigger events. The trigger events can include, but are not limited to, a false conclusion that the user is the authorized or unauthorized user, expiration of a defined period of time, a location of the computing device, an operational characteristic of the computing device, an identity of the user, and/or an identity of an enterprise associated with the user account.

In some illustrative scenarios, the function f is expressed by the following weighted polynomial formula (2).

Sₚᵣₑᵥᵢₒᵤₛ+w₁W_{model} +w₂Dₙₒᵣₘₐₗ+w₃Aₛₜₐₜᵤₛ+w₄Fₐₜₜₑₘₚₜₛ+w₅Sₚᵣₑᵥᵢₒᵤₛ+C−X (2)

where w₁-w₅ represent weights with constant or variable values (e.g., a decimal value falling between 0 and 1). The present solution is not limited to the particulars of this scenario.

The higher the deviation Dₙₒᵣₘₐₗ, the higher the score Sᵤₛₑᵣₐₑₑₒᵤₙₜ. The longer since the user was last authorized, the higher the score S_{useraccount} when deviation is detected. The more recently failed attempts, the higher the score S_{useraccount} when the user is finally authorized and deviation is detected. The higher Sₚᵣₑᵥᵢₒᵤₛ, the higher the score S_{useraccount}.

The normal behavior Dₙₒᵣₘₐₗ is made of multiple components with one of those being the pattern the training model has built from how the user uses the device (e.g., swipes, typing, etc.). Training occurs after account creation and first login and re-training takes place after key events as well. During inference/prediction mode, a confidence level is averaged out from the recent device uses. The lower the confidence level, the higher the deviation is said to be from the norm. Another component of the normal behavior Dₙₒᵣₘₐₗ is the location and time of day (and days of the week) the user normally uses a particular device. The further the location from the normal location range, the higher the deviation. The more outside the normal time and day, the higher the deviation. Such other components are combined when determining what is a normal place and time of usage. For example, a typical normal behavior can be a user who uses a particular device (1) from an office location on non-holiday weekdays during the daytime hours, (2) from home during evenings, weekends and/or holidays. In this case, the place and time components are combined in the determination of normal user behavior relating to those components.

The value of C is determined based on the difference between the confidence value received from the server 108 and a reference confidence value (e.g., 100%). For example, the reference confidence value is 100%. If the confidence value is 90% that the end user is the authorized user, then the value of C is selected to be 1. If the confidence value is 80%, then the value of C is selected to be 2. If the confidence value is 70%, then the value of C is selected to be 3, and so on. The present solution is not limited to the particulars of this example.

The function f can be a function over the aforementioned parameters, and can express a linear or non-linear relation among those parameters. The function f can also be statically defined or may be periodically re-determined in response to trigger events. The trigger events can include, but are not limited to, a false conclusion that the end user is an authorized or unauthorized user of the CD, expiration of a defined period of time (e.g., an hour, a week, a month, a year), a location of the CD, an operational characteristic of the CD, an identity of the end user, and/or an identity of an enterprise associated with the given user account. The function f can be selected from a table containing pre-stored functions, pre-defined rules, and/or by an administrator of server 108. It is possible that in the same deployments multiple functions may be used simultaneously for different device groups depending on the level of security that the administrator wants to impose. The present solution is not limited to the particulars of this scenario. The manner in which the function f is selected can be in accordance with a particular application.

The score S_{useraccount} is compared to a first threshold value thr₁. When the score S_{useraccount} reaches or exceeds the first threshold value thr₁, one or more actions is(are) taken. The actions can include, but are not limited to: (1) logout user and prompt login using the standard authentication process; (2) logout user and prompt login with a different more reliable authorization process (e.g., multi-factor authentication); (3) logout user and lock account in a way that requires unlocking from other secure source (e.g., call to a help desk), or (4) trigger an alarm and start a close monitoring of all subsequent user actions. Other different threshold values thr₂, . . . , thr_{Z} can be used to determine when the actions (1)-(3) are performed. For example, action (1) is performed when the score S_{useraccount} is between 60 and 74. Action (2) is performed when the score S_{useraccount} is between 75 and 84. Action (3) is performed when the score S_{useraccount} is greater than 85. In order to implement this, the score S_{useraccount} is compared with different threshold values starting from the highest threshold value first. Using the threshold values from the example above, the score S_{useraccount} is compared to a value of 85. If the score S_{useraccount} is greater than 85, action (3) is performed. Else, if greater than 75, action (2) is performed. Else, if greater than 60, action (1) is performed. Else, no action is performed. The present solution is not limited to the particulars of this example.

In some scenarios, the different more reliable authorization process involves the use of biometric based technology as an alternative to or in addition to the machine learning based authentication process. The biometric based technology can include, but is not limited to, fingerprint technology, facial recognition technology, and/or voice recognition technology. The present solution is not limited to the particulars of this scenario. The solution may also leverage the CD's built-in biometric capabilities to run the authorization process, and the server will get notified of the process result.

In those or other scenarios, the different authorization process involves the use of a passcode and biometrics. When the end user 112₁ enters a correct passcode to access the CD 104₁ or a resource of the CD 104₁, the CD initiates its facial recognition operations. Facial recognition operations are well known in the art, and therefore will not be described in detail herein. Any known or to be known facial recognition operations can be used herein without limitation. In some scenarios, the facial recognition operations involve: capturing an image of the end user's face; and perform image processing to recognize the end user's face by the CD. The end user's face is recognized by comparing selected facial features from the captured image and a stored reference facial features. If a match exists, the user is provided access to the CD or resource.

The machine learning model training takes place during key periods of time. The key periods of time include, but are not limited to: after initial account creation; after first use; after authorization using the 2-factor authentication process or other authorization process.

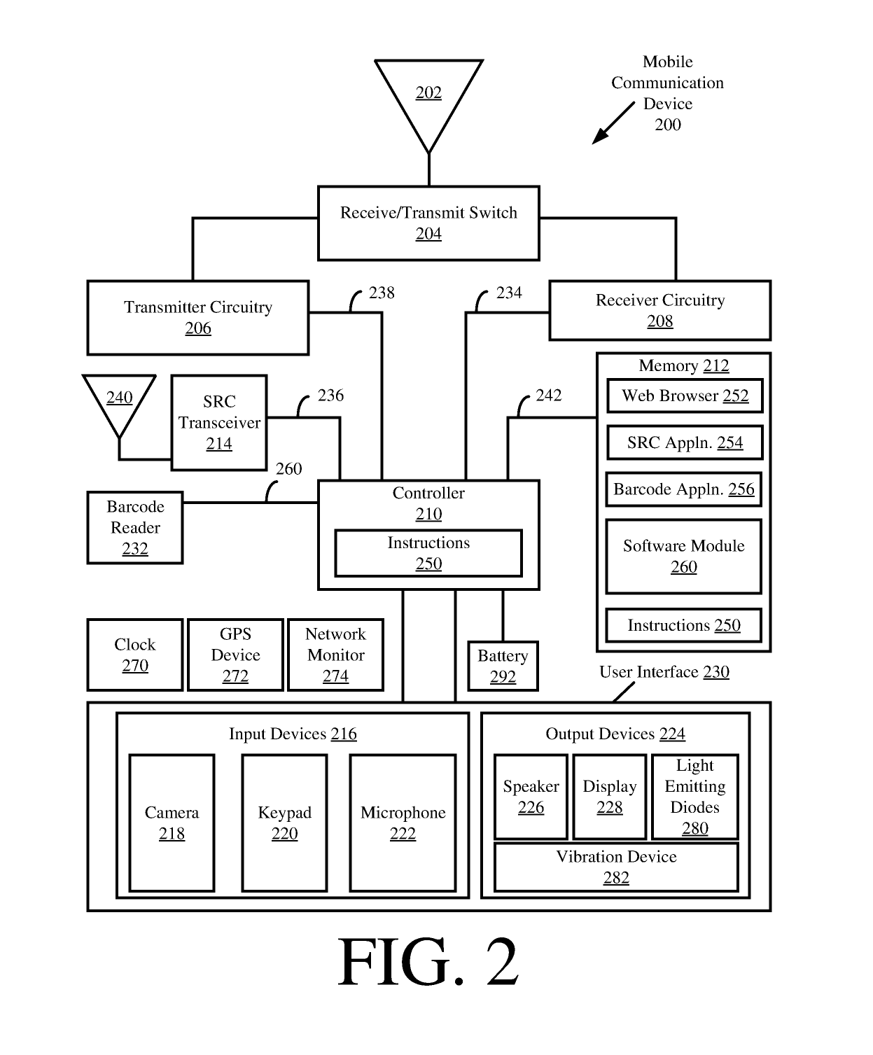

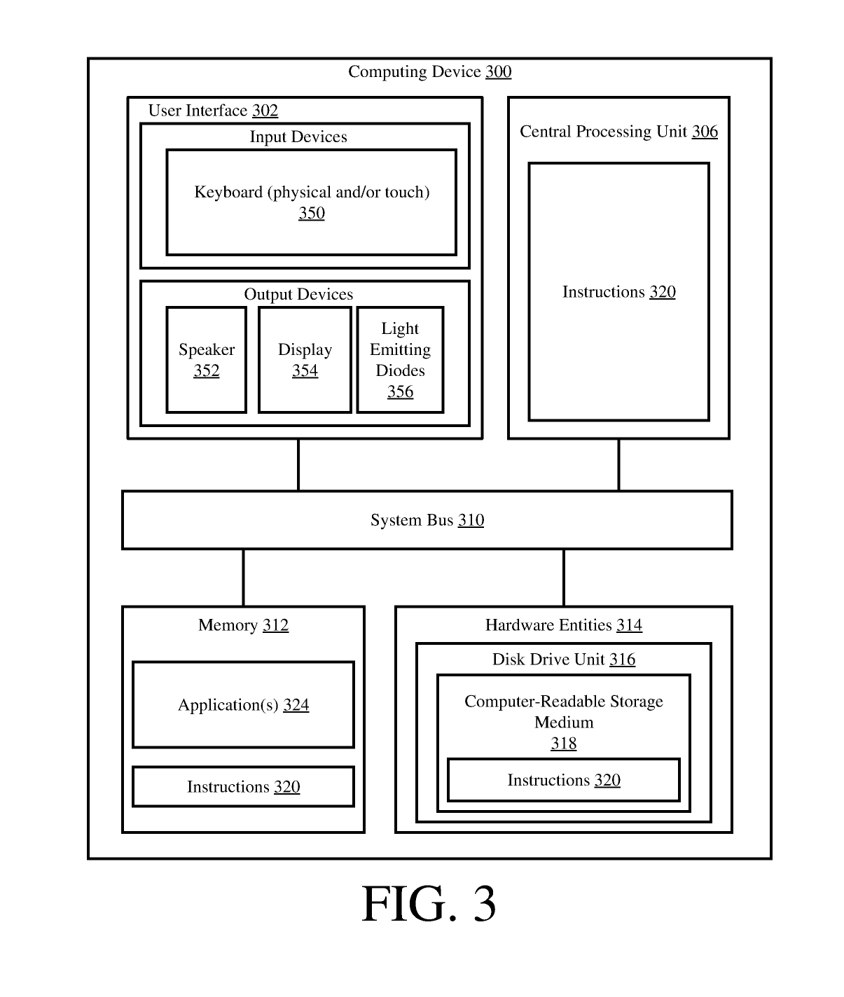

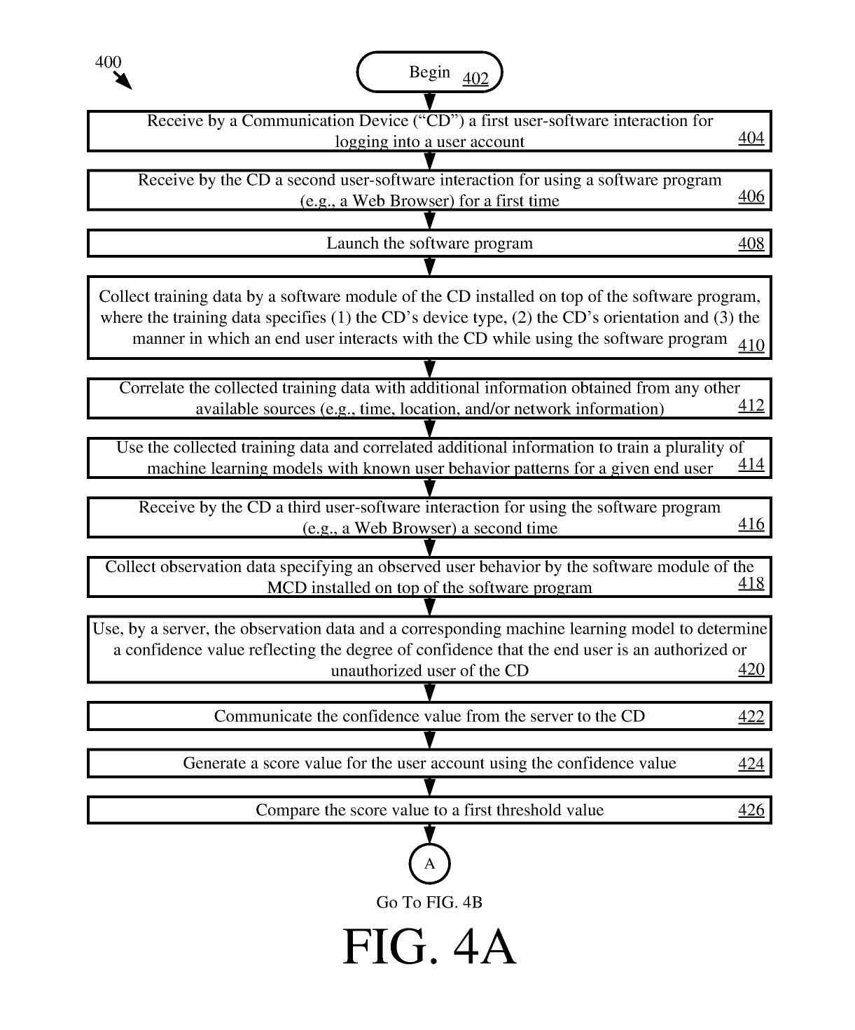

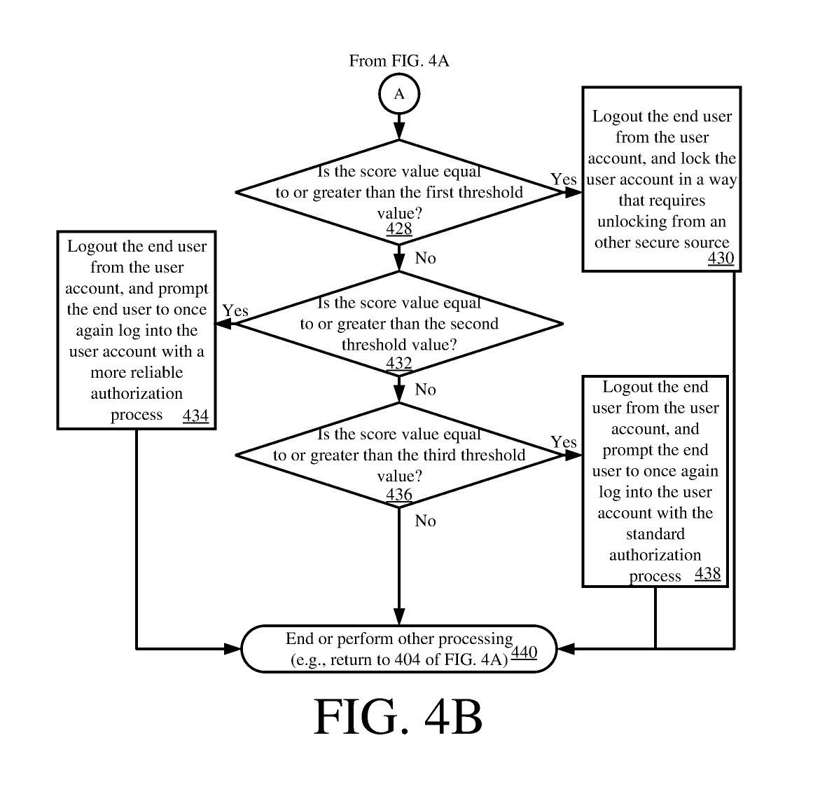

Referring now to FIG. 2, there is provided an illustration of an exemplary architecture for an Mobile Communication Device (“MCD”) 200. CDs 104₁-104_{N} of FIG. 1 can be the same as or similar to MCD 200. As such, the discussion of MCD 200 is sufficient for understanding CDs 104₁-104_{N} of FIG. 1.

MCD 200 may include more or less components than those shown in FIG. 2. However, the components shown are sufficient to disclose an illustrative embodiment implementing the present solution. Some or all of the components of the MCD 200 can be implemented in hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As noted above, the MCD 200 can include, but is not limited to, a notebook computer, a personal digital assistant, a cellular phone, a mobile phone with smart device functionality (e.g., a Smartphone), and/or a wearable device with smart device functionality (e.g., a smart watch). In this regard, the MCD 200 comprises an antenna 202 for receiving and transmitting Radio Frequency (“RF”) signals. A receive/transmit (“Rx/Tx”) switch 204 selectively couples the antenna 202 to the transmitter circuitry 206 and the receiver circuitry 208 in a manner familiar to those skilled in the art. The receiver circuitry 208 demodulates and decodes the RF signals received from an external device. The receiver circuitry 208 is coupled to a controller (or microprocessor) 210 via an electrical connection 234. The receiver circuitry 208 provides the decoded signal information to the controller 210. The controller 210 uses the decoded RF signal information in accordance with the function(s) of the MCD 200. The controller 210 also provides information to the transmitter circuitry 206 for encoding and modulating information into RF signals. Accordingly, the controller 210 is coupled to the transmitter circuitry 206 via an electrical connection 238. The transmitter circuitry 206 communicates the RF signals to the antenna 202 for transmission to an external device via the Rx/Tx switch 204.

The MCD 200 also comprises an antenna 240 coupled to a Short Range Communications (“SRC”) transceiver 214 for receiving SRC signals. SRC transceivers are well known in the art, and therefore will not be described in detail herein. However, it should be understood that the SRC transceiver 214 processes the SRC signals to extract information therefrom. The SRC transceiver 214 may process the SRC signals in a manner defined by the SRC application 254 installed on the MCD 200. The SRC application 254 can include, but is not limited to, a Commercial Off the Shelf (“COTS”) application (e.g., a Bluetooth application). The SRC transceiver 214 is coupled to the controller 210 via an electrical connection 236. The controller uses the extracted information in accordance with the function(s) of the MCD 200.

The controller 210 may store received and extracted information in memory 212 of the MCD 200. Accordingly, the memory 212 is connected to and accessible by the controller 210 through electrical connection 242. The memory 212 may be a volatile memory and/or a non-volatile memory. For example, memory 212 can include, but is not limited to, a Random Access Memory (“RAM”), a Dynamic RAM (“DRAM”), a Read Only Memory (“ROM”) and a flash memory. The memory 212 may also comprise unsecure memory and/or secure memory. The memory 212 can be used to store various other types of data 260 therein, such as authentication information, cryptographic information, location information, and various work order related information.

The MCD 200 also may comprise a barcode reader 232. Barcode readers are well known in the art, and therefore will not be described herein. However, it should be understood that the barcode reader 232 is generally configured to scan a barcode and process the scanned barcode to extract information therefrom. The barcode reader 232 may process the barcode in a manner defined by the barcode application 256 installed on the MCD 200. Additionally, the barcode scanning application can use camera 218 to capture the barcode image for processing. The barcode application 256 can include, but is not limited to, a COTS application. The barcode reader 232 provides the extracted information to the controller 210. As such, the barcode reader 232 is coupled to the controller 210 via an electrical connection 260. The controller 210 uses the extracted information in accordance with the function(s) of the MCD 200. For example, the extracted information can be used by MCD 200 to enable user authentication functionalities thereof.

As shown in FIG. 2, one or more sets of instructions 250 are stored in memory 212. The instructions may include customizable instructions and non-customizable instructions. The instructions 250 can also reside, completely or at least partially, within the controller 210 during execution thereof by MCD 200. In this regard, the memory 212 and the controller 210 can constitute machine-readable media. The term “machine-readable media”, as used herein, refers to a single medium or multiple media that stores one or more sets of instructions 250. The term “machine-readable media”, as used here, also refers to any medium that is capable of storing, encoding or carrying the set of instructions 250 for execution by the MCD 200 and that causes the MCD 200 to perform one or more of the methodologies of the present disclosure.

The controller 210 is also connected to a user interface 230. The user interface 230 comprises input devices 216, output devices 224 and software routines (not shown in FIG. 2) configured to allow a user to interact with and control software applications (e.g., software applications 252-256 and other software applications) installed on the MCD 200. Such input and output devices may include, but are not limited to, a display 228, a speaker 226, a keypad 220, a directional pad (not shown in FIG. 2), a directional knob (not shown in FIG. 2), a microphone 222, and a camera 218. The display 228 may be designed to accept touch screen inputs. As such, user interface 230 can facilitate a user software interaction for launching applications (e.g., applications 252-260 and other software applications) installed on the MCD 200. The user interface 230 can facilitate a user-software interactive session for: initiating communications with an external device; writing data to and reading data from memory 212; and/or initiating user authentication operations for authenticating a user (e.g., such that a remote session between a nearby client computing device and a remote cloud service server).

The display 228, keypad 220, directional pad (not shown in FIG. 2) and directional knob (not shown in FIG. 2) can collectively provide a user with a means to initiate one or more software applications or functions of the MCD 200. The application software 252-260 can facilitate the data exchange (a) a user and the MCD 200, and/or (b) the MCD 200 and another device. In this regard, the application software 252-260 performs one or more of the following: facilitate verification of that the user of the MCD 200 is an authorized user via a one-factor or a two-factor authentication process; and/or present information to the user indicating that (s)he is or is not authorized to use the resource.

Referring now to FIG. 3, there is provided an illustration of an exemplary architecture for a computing device 300. CDs 104₁-104_{N} and/or server(s) 108 of FIG. 1 (is)are the same as or similar to server 300. As such, the discussion of computing device 300 is sufficient for understanding these components of system 100.

Computing device 300 may include more or less components than those shown in FIG. 3. However, the components shown are sufficient to disclose an illustrative solution implementing the present solution. The hardware architecture of FIG. 3 represents one implementation of a representative computing device configured to enable watermarking of graphics, as described herein. As such, the computing device 300 of FIG. 3 implements at least a portion of the method(s) described herein.

Some or all the components of the computing device 300 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 3, the computing device 300 comprises a user interface 302, a Central Processing Unit (“CPU”) 306, a system bus 310, a memory 312 connected to and accessible by other portions of computing device 300 through system bus 310, and hardware entities 314 connected to system bus 310. The user interface can include input devices and output devices, which facilitate user-software interactions for controlling operations of the computing device 300. The input devices include, but are not limited, a physical and/or touch keyboard 350. The input devices can be connected to the computing device 300 via a wired or wireless connection (e.g., a Bluetooth® connection). The output devices include, but are not limited to, a speaker 352, a display 354, and/or light emitting diodes 356.

At least some of the hardware entities 314 perform actions involving access to and use of memory 312, which can be a Radom Access Memory (“RAM”), a disk driver and/or a Compact Disc Read Only Memory (“CD-ROM”). Hardware entities 314 can include a disk drive unit 316 comprising a computer-readable storage medium 318 on which is stored one or more sets of instructions 320 (e.g., software code) configured to implement one or more of the methodologies, procedures, or functions described herein. The instructions 320 can also reside, completely or at least partially, within the memory 312 and/or within the CPU 306 during execution thereof by the computing device 300. The memory 312 and the CPU 306 also can constitute machine-readable media. The term “machine-readable media”, as used here, refers to a single medium or multiple media (e.g., a centralized or distributed database, and/or associated caches and servers) that store the one or more sets of instructions 320. The term “machine-readable media”, as used here, also refers to any medium that is capable of storing, encoding or carrying a set of instructions 320 for execution by the computing device 300 and that cause the computing device 300 to perform any one or more of the methodologies of the present disclosure.

Referring now to FIG. 4, there is shown a flow diagram of an illustrative method 400 for authenticating device users through behavioral analysis. Method 400 comprises a plurality of blocks. The present solution is not limited to the order of the blocks shown in FIG. 4. The operations of the blocks can be performed in a different order (than that shown) in accordance with a given application.

As shown in FIG. 4A, method 400 begins with 402 and continues with 404 where a CD (e.g., CD 104₁ . . . , or 104_{N} of FIG. 1) receives a first user-software interaction for logging into a user account. User-software interactions for logging into user accounts are well known in the art, and therefore will not be described herein. Any known or to be known user-software interaction for logging into a user account can be employed herein. The first user-software interaction can be achieved using an input device (e.g., keypad 220 of FIG. 2 or keyboard 350 of FIG. 3) of the CD.

In 406, the CD also receives a second user-software interaction for using a software program (e.g., Web Browser 116₁ . . . , or 116_{N} of FIG. 1) for the first time. User-software interactions for using software programs are well known in the art, and therefore will not be described herein. Any known or to be known user-software interaction for using a software program can be employed herein. The second user-software interaction can also be achieved using an input device (e.g., keypad 220 of FIG. 2 or keyboard 350 of FIG. 3) of the CD. In response to the second user-software interaction, the software program is launched as shown by 408.

Next in 410, training data is collected by a software module (e.g., software module 114₁ . . . , or 114_{N} of FIG. 1) installed on top of the software program. The training data specifies at least (1) the CD's device type (e.g., mobile phone, table, desktop, etc.), (2) the CD's screen size, (3) the CD's operating system, (4) the CD's orientation, (5) other CD capabilities (e.g., presence of biometric sensors, touch screen force sensors, etc.), and (6) the manner in which an end user interacts with the CD while using the software program. For example, the training data indicates: (a) the speed, angle and force associated with a swipe gesture made using a particular software application (e.g., Web Browser 116₁ . . . , 116_{N} of FIG. 1, an email application, or an editor application) installed on a particular type of device (e.g., smart phone or tablet) in a specific orientation (e.g., portrait or landscape); and/or (b) the speed, finger placement and force associated with keyboard typing of specific keys or pre-defined sequences of keys while using a particular software application (e.g., an email application or an editor application) installed on a particular type of device (e.g., smart phone or tablet) in a specific orientation (e.g., portrait or landscape). The present solution is not limited to the particulars of this example. The collected training data is then correlated in 412 with additional information obtained from other available sources (e.g., time determined by a clock 270 of FIG. 2, location determined by a local Global Positioning System (“GPS”) device 272 of FIG. 2, and/or network information obtained from a network monitor 274 of FIG. 2).

In 414, the collected training data and correlated additional information is communicated from the CD to a server (e.g., server 108 of FIG. 1). At the server, the collected training data and correlated additional information is used in 414 to train a plurality of machine learning models with known user behavior patterns for a given end user (e.g., end user 102 of FIG. 1).

Subsequently, method 400 continues with 416 where the CD receives a third user-software interaction for using the software program a second time. While the software program is being used, the software module (e.g., software module 114₁ . . . , or 114_{N} of FIG. 1) collects observation data specifying an observed user behavior, as shown by 418. For example, the observation data indicates: (a) the speed, angle and force associated with a swipe gesture made using a particular software application (e.g., Web Browser 116₁ . . . , 116_{N} of FIG. 1, an email application, or an editor application) installed on a particular type of device (e.g., smart phone or tablet) in a specific orientation (e.g., portrait or landscape); and/or (b) the speed, finger placement and force associated with keyboard typing of specific keys or pre-defined sequences of keys while using a particular software application (e.g., an email application or an editor application) installed on a particular type of device (e.g., smart phone or tablet) in a specific orientation (e.g., portrait or landscape). The present solution is not limited to the particulars of this example. The observation data may also specify a time at which each user-software interaction occurred, a location of the CD when each user-software interaction was performed, and/or a network characteristic at the time each user-software interaction was performed.

In next 420, the observation data is sent from the CD to the server. At the server, the observation data and a corresponding machine learning model is used to determine a confidence value reflecting the degree of confidence that the end user is an authorized user of the CD or an unauthorized user of the CD. In some scenarios, the confidence value is determined based on the degree to which a newly observed user behavior matches the known user behavior patterns defined by the corresponding machine learning model. The confidence value is then communicated from the server to the CD, as shown by 422. The present solution is not limited to the operations of 420-422. In other scenarios, the confidence value is determined by the CD rather than the server, as discussed above in paragraph [0029].

At the CD, a score value S_{useracount} is determined for the user account associated therewith. The score value is determined in accordance with Mathematical Equation (1) presented above. As explained above, the confidence value is used to determine the score value S_{useracount}. The score value is then compared to a first threshold value thri, as shown by 426.

Referring now to FIG. 4B, if the score value S_{useracount} is equal to or greater than the first threshold value thr₁ (e.g., 85) [428:YES], method 400 continues with block 430 where the following actions are performed: logout the end user from the user account, and lock the user account in a way that requires unlocking from another secure source (e.g., a remote server). Upon completing 430, method 400 continues with 440 which will be described below. If the score value S_{useracount} is less than the first threshold value thri [428:N0], then 432 is performed where a determination is made as to whether the score value S_{useracount} is equal to or greater than a second threshold value thr2 (e.g., 75).

If the score value S_{useracount} is equal to or greater than a second threshold value thr₂ [432:YES], method 400 continues with block 434 where the following actions are performed: logout the end user from the user account, and prompt the end user to once again log into the user account with a more reliable authorization process. Next, method 400 continues with 440 which will be described below. If the score value S_{useracount} is less than a second threshold value thr₂ [432:N0], method 400 continues block 436 where a determination is made as to whether the score value S_{useracount} is equal to or greater than a third threshold value thr₃ (e.g., 60).

If the score value S_{useracount} is equal to or greater than the third threshold value thr3 [436:YES], then method 400 continues with block 438 where the following operations are performed: logout the end user from the user account, and prompt the end user to once again log into the user account with the standard authorization process. Thereafter, method 400 continues with 440 which will be described below. If the score value S_{useracount} is less than the third threshold value thr3 [436:NO], then 440 is performed where method 400 ends or other processing is performed (e.g., return to 404 so that the process is repeated).

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

What is claimed is:

1. A method for authenticating a user through behavioral analysis, comprising:
collecting, by a computing device, observation data specifying an observed behavior of the user while interacting with the computing device;
obtaining, by a computing device, a confidence value reflecting a degree of confidence that the user is an authorized user of the computing device or an unauthorized user of the computing device, where the confidence value is determined based on the observation data and a machine learning model trained with a known behavior pattern of the authorized user;
using at least the confidence value and the observed behavior's amount of deviation from a normal behavior pattern to derive a risk level score value for a user account to which the computing device is associated;
comparing, by a computing device, the risk level score value to a threshold value; and
performing, by the computing device, at least one action to protect user account security when the threshold value is equal to or greater than the threshold value.

2. The method according to claim 1, further comprising collecting, by the computing device, training data specifying (1) the computing device's device type, (2) the computing device's screen size, (3) the computing device's operating system, (4) the computing device's orientation, (5) computing device capabilities, and (6) a manner in which the user interacted with the computing device while using a software application.

3. The method according to claim 2, further comprising using the training data to train the machine learning module with the known behavior pattern of the authorized user.

4. The method according to claim 3, wherein the training data is collected during a first time period when the user first logs into the user account, during a second time period when the software application is being used by the user for a first time, or during a third time period immediately after a successful authentication of the user.

5. The method according to claim 1, wherein the observation data specifies (1) the computing device's device type, (2) the computing device's screen size, (3) the computing device's operating system, (4) the computing device's orientation, (5) computing device capabilities, and (6) a manner in which the user interacted with the computing device while using a software application.

6. The method according to claim 1, wherein the risk level score value is defined by the following Mathematical Equation
S_{useraccount}=f(Sₚᵣₑᵥᵢₒᵤₛ, W_{model}, Dₙₒᵣₘₐₗ, Aₛₜₐₜᵤₛ, Fₐₜₜₑₘₚₜₛ, C, X)
where S_{useracount} represents the risk level score value for the user account, W_{model} represents a weight value given to the computing device's device type, Dₙₒᵣₘₐₗ represents the observed behavior' s amount of deviation from the normal behavior pattern, Aₛₜₐₜᵤₛ represents a current authorization status, Fₐₜₜₑₘₚₜₛ represents a number of recently failed authorization attempts, Sₚᵣₑᵥᵢₒᵤₛ represents a previous risk level score value determined for the user account, C represents a number determined based on the confidence value, X represents a number dynamically selected from a set of pre-defined numbers based on a pre-defined criteria, f represents a function over all aforementioned parameters.

7. The method according to claim 6, wherein the predefined criteria comprises at least one of a time since a low confidence level was obtained, a time since Dₙₒᵣₘₐₗ exceeded a threshold value, and a type of authentication method last used to authenticate the user's identity.

8. The method according to claim 6, where the value of C is determined based on the difference between the confidence value and a reference confidence value.

9. The method according to claim 6, wherein f describes a linear or non-linear relation between Sₚᵣₑᵥᵢₒᵤₛ, W_{model}, Dₙₒᵣₘₐₗ, Aₛₜₐₜᵤₛ, Fₐₜₜₑₘₚₜₛ, C, and X, and is statically defined or periodically re-determined in response to trigger events.

10. The method according to claim 9, wherein the trigger events comprise at least one of a false conclusion that the user is the authorized or unauthorized user, expiration of a defined period of time, a location of the computing device, an operational characteristic of the computing device, an identity of the user, and an identity of an enterprise associated with the user account.

11. A system, comprising:
a processor; and
a non-transitory computer-readable storage medium comprising programming instructions that are configured to cause the processor to implement a method for authenticating a user through behavioral analysis, wherein the programming instructions comprise instructions to:
collect observation data specifying an observed behavior of the user while interacting with a computing device;
obtaining a confidence value reflecting a degree of confidence that the user is an authorized user of the computing device or an unauthorized user of the computing device, where the confidence value is determined based on the observation data and a machine learning model trained with a known behavior pattern of the authorized user;
using at least the confidence value and the observed behavior's amount of deviation from a normal behavior pattern to derive a risk level score value for a user account to which the computing device is associated;
comparing the risk level score value to a threshold value; and
causing at least one action to protect user account security to be performed by the computing device when the threshold value is equal to or greater than the threshold value.

12. The system according to claim 11, wherein the programming instructions further comprise instructions to collect training data specifying (1) the computing device's device type, (2) the computing device's screen size, (3) the computing device's operating system, (4) the computing device's orientation, (5) computing device capabilities, and (6) a manner in which the user interacted with the computing device while using a software application.

13. The system according to claim 12, wherein the programming instructions further comprise instructions to use the training data to train the machine learning module with the known behavior pattern of the authorized user.

14. The system according to claim 13, wherein the training data is collected during a first time period when the user first logs into the user account, during a second time period when the software application is being used by the user for a first time, or during a third time period immediately after a successful authentication of the user.

15. The system according to claim 11, wherein the observation data specifies (1) the computing device's device type, (2) the computing device's screen size, (3) the computing device's operating system, (4) the computing device's orientation, (5) computing device capabilities, and (6) a manner in which the user interacted with the computing device while using a software application.

16. The system according to claim 11, wherein the risk level score value is defined by the following Mathematical Equation
S_{useraccount}=f(Sₚᵣₑᵥᵢₒᵤₛ, W_{model}, Dₙₒᵣₘₐₗ, Aₛₜₐₜᵤₛ, Fₐₜₜₑₘₚₜₛ, C, X)
where S_{useracount} represents the risk level score value for the user account, W_{model} represents a weight value given to the computing device's device type, Dₙₒᵣₘₐₗ represents the observed behavior' s amount of deviation from the normal behavior pattern, Aₛₜₐₜᵤₛ represents a current authorization status, Fₐₜₜₑₘₚₜₛ represents a number of recently failed authorization attempts, Sₚᵣₑᵥᵢₒᵤₛ represents a previous risk level score value determined for the user account, C represents a number determined based on the confidence value, X represents a number dynamically selected from a set of pre-defined numbers based on a pre-defined criteria, f represents a function over all aforementioned parameters.

17. The system according to claim 16, wherein the predefined criteria comprises at least one of a time since a low confidence level was obtained, a time since Dₙₒᵣₘₐₗ exceeded a threshold value, and a type of authentication method last used to authenticate the user's identity.

18. The system according to claim 16, where the value of C is determined based on the difference between the confidence value and a reference confidence value.

19. The system according to claim 16, wherein f describes a linear or non-linear relation between Sₚᵣₑᵥᵢₒᵤₛ, W_{model}, Dₙₒᵣₘₐₗ, Aₛₜₐₜᵤₛ, Fₐₜₜₑₘₚₜₛ, C, and X, and is statically defined or periodically re-determined in response to trigger events.

20. The system according to claim 19, wherein the trigger events comprise at least one of a false conclusion that the user is the authorized or unauthorized user, expiration of a defined period of time, a location of the computing device, an operational characteristic of the computing device, an identity of the user, and an identity of an enterprise associated with the user account.
